(19) United States
(12) Patent Application Publication
(10) Pub. No.: US 2015/0084957 A1
(43) Pub. Date: Mar. 26, 2015

(54) METHOD AND APPARATUS FOR ROUTING DATA AND RECONFIGURING RENDERING UNIT

(71) Applicant: SAMSUNG ELECTRONICS CO., LTD., Suwon-si (KR)

(72) Inventors: Young-sam SHIN, Hwaseong-si (KR); Woong SEO, Hwaseong-si (KR); Won-jong LEE, Seoul (KR); Jae-don LEE, Yongin-si (KR)

(73) Assignee: SAMSUNG ELECTRONICS CO., LTD., Suwon-si (KR)

(21) Appl. No.: 14/261,942

(22) Filed: Apr. 25, 2014

(30) Foreign Application Priority Data
Sep. 25, 2013 (KR) 10-2013-0114145

(51) Int. Cl. G06T 15/06; G06T 15/00

(52) U.S. Cl. CPC G06T 15/06; G06T 15/005; G06T 2200/04; G06T 2200/28
USPC 345/426

(57) ABSTRACT

Provided are method and apparatuses for routing and reconfiguring rendering data, the method for routing including identifying, at a processor, a group of input data, transmitting the input data based on a routing path designated for the identified group, and updating the routing path based on a feedback signal regarding the transmitted data. The method for reconfiguring rendering units including measuring, at a processor, workloads of the rendering units used in rendering a previous frame, and reconfiguring the rendering units during rendering a current frame based on the workloads.

### RELATED APPLICATIONS

This application claims the benefit under 35 U.S.C. §119(a) of Korean Patent Application No. 10-2013-0114145, filed on Sep. 25, 2013, in the Korean Intellectual Property Office, the entire disclosure of which is hereby incorporated herein by reference for all purposes.

### BACKGROUND

1. Field

The following description relates to methods and apparatuses for routing data and a multi-core system.

2. Description of Related Art

In a Network-on-Chip (NoC)-based multi-core system, a routing method of transmitting input data to multiple cores is used. A core to which data is to be transmitted needs to contain information about the data. If the information about the data is not contained in the core, the data is transmitted to another core. The performance of a multi-core system decreases with the increase in the number of times that the data is retransmitted. Accordingly, a method of transmitting data to a core that is to process the data is required.

3D rendering refers to image processing where 3D object data is synthesized to an image viewed at a given viewpoint of a camera. Ray tracing refers to a process of tracing a point where scene objects and a ray intersect. Ray tracing includes traversal of an acceleration structure and an intersection test between a ray and a primitive.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect there is provided a routing method including identifying, at a processor, a group of input data, transmitting the input data through a designated routing path, and updating the routing path based on a feedback signal corresponding to the transmitted data.

The updating of the routing path may comprise updating the routing path based on paths through which feedback signals of the group are transmitted and information included in the feedback signals.

The input data may be ray data for ray tracing, the transmitting of the ray data may comprise transmitting the ray data to a traversal (TRV) unit or an intersection test (IST) unit designated to the routing path, and the updating of the routing path may comprise updating the routing path to a TRV unit or an IST unit from where a feedback signal indicating a most recent hit result is transmitted from ray data of the group.

The input data may be ray data for ray tracing, the transmitting of the ray data may comprise transmitting the ray data to a traversal (TRV) unit or an intersection test (IST) unit, and the updating of the routing path may comprise updating the routing path to a path through which a feedback signal indicating a hit result is most likely transmitted from ray data of the same group.

The input data may include at least one of information on rays generated for ray tracing or information for rendering, and the group is assigned to the data based on a viewpoint and a direction of the rays.

The input data may include information about the rays generated for ray tracing, and the transmitting of the input data may comprise transmitting the input data, to a processing unit set as a traversal (TRV) unit or an intersection test (IST) unit.

In response to initial ray data being included in the group of the input data, the transmitting of the input data may comprise transmitting the initial ray data to all traversal (TRV) units or to all intersection test (IST) units.

In response to information indicating presence of an intersection result regarding another data being included in the group of the input data, the transmitting of the input data may comprise transmitting the data to a traversal (TRV) unit or an intersection test (IST) unit based on the intersection result.

In another general aspect there is provided a router including a controller configured to identify a group of input data, and a transmitter configured to transmit the input data through a designated routing path, wherein the controller is further configured to update the routing path based on a feedback signal corresponding to the transmitted data.

The controller may be further configured to update the routing path based on paths through which feedback signals of the group are transmitted and information included in the feedback signals.

The input data may be ray data for ray tracing, and the transmitter may be further configured to transmit the ray data to a traversal (TRV) unit or an intersection test (IST) unit designated to the routing path, and the controller may be further configured to update the routing path to a TRV unit or an IST unit from where a feedback signal indicating a most recent hit result is transmitted from ray data of the group.

The input data may be ray data for ray tracing, and the transmitter may be further configured to transmit the ray data to a traversal (TRV) unit or an intersection test (IST) unit, and the controller may be further configured to update the routing path to a path through which a feedback signal indicating a hit result is most likely transmitted from ray data of the same group.

The input data may include at least one of information on rays generated for ray tracing or information for rendering, and the group may be assigned to the data based on a viewpoint and a direction of the rays.

The input data may include information about the rays generated for ray tracing, and the transmitter may be further configured to transmit the data to a processing unit set as a traversal (TRV) unit or an intersection test (IST) unit.

In response to the initial ray data being included in the group of the input data, the transmitter may be further configured to transmit the initial ray data to all traversal (TRV) units or to all intersection test (IST) units.

In response to information indicating presence of an intersection result regarding another data being included in the group of the input data, the transmitter may be further configured to transmits the data to a traversal (TRV) unit or an intersection test (IST) unit based on the intersection result.

In response to information indicating whether a processing unit has utilized the transmitted data, the controller may be further configured to update the routing path.

In another general aspect there is provided a method of reconfiguring rendering units, the method including measuring, at a processor, workloads of the rendering units used in rendering a previous frame, and reconfiguring the rendering units during rendering a current frame based on the workloads.

The rendering units may comprise at least one of a ray generator, a traversal (TRV) unit, an intersection test (IST) unit, or a shading unit.

The rendering units may comprise at least one of a vertex shader, a primitive generator, a raster, or a pixel shader.

In response to performing rendering of a primary ray during ray tracing, a ray generator and a traversal (TRV) unit may be allocated to a single processing unit.

The rendering units may be used in ray tracing, the measuring of the workloads may comprise measuring a degree of reflection or refraction based on a structure of an object included in 3D space and material characteristics of the object, and the reconfiguring of the rendering units may comprise determining a number of traversal (TRV) units to be allocated based on the measured degree of reflection and refraction.

In response to performing rendering of a secondary ray during ray tracing, a shading unit and a ray generator may be allocated to a single processing unit.

In another general aspect there is provided an apparatus for reconfiguring rendering units, the apparatus including a workload measurer configure to measure workloads of the rendering units used in rendering of a previous frame, and a reconfigurer configure to reconfigure the rendering units during rendering of a current frame based on the workloads.

The rendering units may comprise at least one of a ray generator, a traversal (TRV) unit, an intersection test (IST) unit, or a shading unit.

In response to performing rendering of a primary ray during ray tracing, a ray generator and a traversal (TRV) unit may be allocated to a single processing unit.

The rendering units may be used in ray tracing, the workload measurer may be further configured to measure a degree of reflection or refraction based on a structure of an object included in 3D space and material characteristics of an object, and the reconfigurer may be further configured to allocate the number of traversal (TRV) units based on the measured degree of reflection and refraction.

In response to performing rendering of a secondary ray during ray tracing, a shading unit and a ray generator may be allocated to a single processing unit.

Other features and aspects will be apparent from the following detailed description, the drawings, and the claims.

### BRIEF DESCRIPTION OF THE DRAWINGS

FIG. 1 is a diagram illustrating an example of ray tracing.

FIG. 2 is a diagram illustrating an example of a ray tracing core.

FIG. 3 is a diagram illustrating an example of ray tracing performed by a ray tracing core.

FIG. 4 is a diagram illustrating an example of a method of accelerating ray tracing.

FIG. 5 is a diagram illustrating an example of a method of accelerating ray tracing of FIG. 4.

FIG. 6 is a diagram illustrating an example of a router.

FIG. 7 is a diagram illustrating an example of a router.

FIG. 8 is a diagram illustrating an example of a router.

FIG. 9 is a diagram illustrating an example of a method of routing ray data, performed by the router of FIG. 6.

FIG. 10 is a diagram illustrating an example of an operation of updating a routing table, performed by a router.

FIG. 11 is a diagram illustrating examples of packets that are transmitted or received using a router.

FIG. 12 is a diagram illustrating an example of a network on chip (NoC).

FIG. 13 is a diagram illustrating an example of a routing table.

FIG. 14 is a diagram illustrating an example of a routing method.

FIG. 15 is a diagram illustrating an example of a reconfiguring apparatus.

FIG. 16 is a diagram illustrating an example of rendering units assigned to processing units.

FIG. 17 is a diagram illustrating examples of rendering units assigned to processing units.

FIG. 18 is a diagram illustrating an example of a reconfiguring method of rendering units.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the systems, apparatuses and/or methods described herein will be apparent to one of ordinary skill in the art. The progression of processing steps and/or operations described is an example; however, the sequence of and/or operations is not limited to that set forth herein and may be changed as is known in the art, with the exception of steps and/or operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

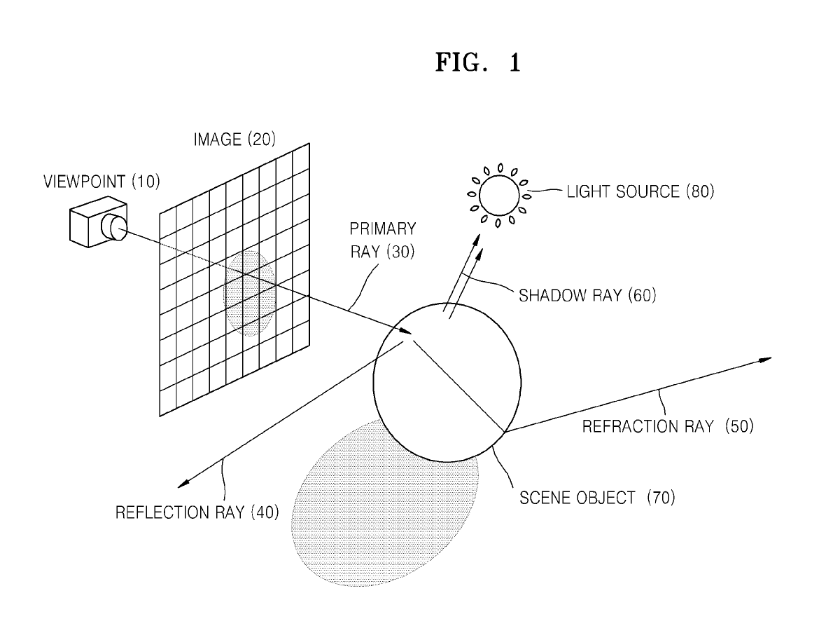

FIG. 1 is a diagram illustrating an example of ray tracing. Referring to FIG. 1, in three-dimensional (3D) modeling, a ray tracing core may determine a viewpoint 10 and an image 20 based on the viewpoint 10. When the viewpoint 10 and the image 20 are determined, the ray tracing core generates a ray from the viewpoint 10 with respect to each pixel of the image 20.

In ray tracing, a primary ray 30 is generated from the viewpoint 10. The primary ray 30 intersects with a scene object 70 after passing the image 20. At an intersection point between the primary ray 30 and the scene object 70, a reflection ray 40 and a refraction ray 50 are generated. Also, a shadow ray 60 is generated at the intersection point toward a light source 80. The reflection ray 40, the refraction ray 50, and the shadow ray 60 are referred to as secondary rays. The scene object 70 denotes an object that is to be rendered with respect to the image 20. The scene object 70 includes a plurality of primitives.

The ray tracing core analyzes the primary ray 30, the secondary rays, i.e, the reflection ray 40, the refraction ray 50, and the shadow ray 60, and other rays derived from the secondary rays. The ray tracing core determines a color value of each of the pixels that form the image 20 based on a result of the analysis. The ray tracing core determines color values of pixels by considering characteristics of the scene object 70.

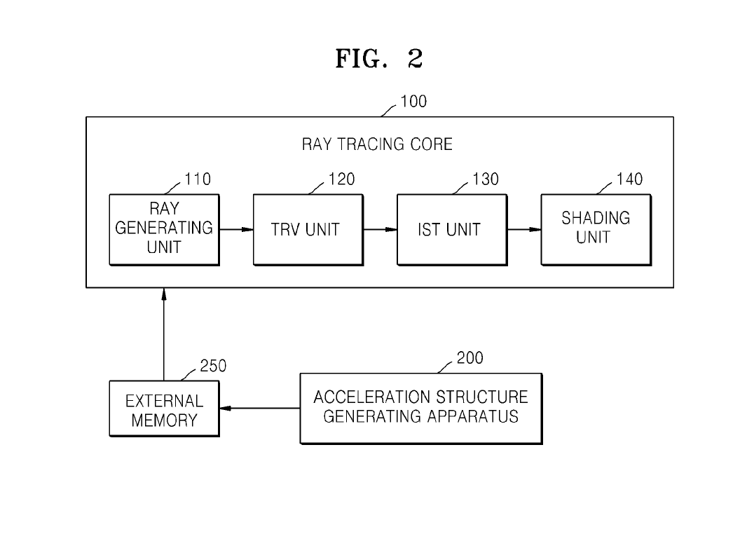

FIG. 2 is a diagram illustrating an example of a ray tracing core 100. Referring to FIG. 2, the ray tracing core 100 includes a ray generating unit 110, a traversal (TRV) unit 120, an intersection test (IST) unit 130, and a shading unit 140. In FIG. 2, the TRV unit 120 and the IST unit 130 are included in the ray tracing core 100, but the TRV unit 120 and the IST unit 130 may also be provided separately without departing from the spirit and scope of the illustrative examples described. The ray tracing core 100 of FIG. 2 includes only elements related to the illustrated example. However, it is understood that those skilled in the art may include other general elements in the ray tracing core 100.

The ray tracing core 100 traces an intersection point between generated rays and objects located in 3D space, and determines color values of pixels that form an image. The ray tracing core 100 searches for an intersection point between rays and objects, generates secondary rays based on characteristics of an object at the intersection point, and determines a color value of the intersection point. The ray tracing core 100 may use results of previous traversal and previous intersection tests in traversal of an acceleration structure and an intersection test. The ray tracing core 100 may perform current rendering faster by applying results obtained from previous renderings.

The ray generating unit 110 generates a primary ray and a secondary ray. The ray tracing core 100 generates a primary ray 30 from a viewpoint 10. The ray generating unit 110 generates a secondary ray at an intersection point between the primary ray 30 and an object 70. The ray generating unit 110 may generate a second secondary ray at an intersection point between the secondary ray and the object 70. The ray generating unit 110 may generate a reflection ray 40, a refraction ray 50, or a shadow ray 60 at an intersection point between the secondary ray and the object 70. The ray generating unit 110 may generate a reflection ray 40, a refraction ray 50, or a shadow ray 60 within a preset number of times. In another non-exhaustive example, the ray generating unit 110 may determine the number of times required to generate a reflection ray 40, a refraction ray 50, or a shadow ray 60 based on characteristics of an object 70.

The TRV unit 120 receives information about a ray generated by the ray generating unit 110. The generated ray may be a primary ray 30, a secondary ray, or a ray derived from the secondary ray. For example, regarding a primary ray 30, the TRV unit 120 may receive information about a viewpoint and a direction of a generated ray. Regarding a secondary ray, the TRV unit 120 may receive information about a starting point and a direction of a secondary ray. A starting point of a secondary ray denotes a point in a primitive that a primary ray has hit. A viewpoint or a starting point may be expressed in coordinates, and a direction may be expressed in vector notation.

The TRV unit 120 reads information about an acceleration structure from an external memory 250. An acceleration structure is generated by an acceleration structure generating apparatus 200, and the generated acceleration structure is stored in the external memory 250. An acceleration structure refers to a structure including position information of objects in 3D space. For example, an acceleration structure may be a K-dimensional (KD) tree or a bounding volume hierarchy (BVH).

The TRV unit 120 traverses an acceleration structure to output an object or a leaf node that a ray has hit. The TRV unit 120 searches for nodes included in an acceleration structure to output a leaf node, which a ray has hit, from among lowermost-ranking leaf nodes, to the IST unit 130. The TRV unit 120 determines which of bounding boxes that form an acceleration structure is hit by a ray. The TRV unit 120 determines which of objects included in a bounding box is hit by a ray. The TRV unit 120 stores information about an object that has been hit in a TRV cache. A bounding box denotes a unit including a plurality of objects or a plurality of primitives. A bounding box may be expressed in different forms according to an acceleration structure.

The TRV unit 120 may traverse an acceleration structure based on results of previous rendering. The TRV unit 120 may traverse an acceleration structure through the same route as a previous rendering based on the result of previous rendering that is stored in a TRV cache. When the TRV unit 120 traverses an acceleration structure regarding an input ray, the TRV unit 120 may initially traverse a bounding box that is hit by a previous ray having the same viewpoint and the same direction as the input ray. Also, the TRV unit 120 may traverse an acceleration structure by referring to a search route with respect to a previous ray. A TRV cache denotes a memory to temporarily store data used by the TRV unit 120 during traversal.

The IST unit 130 receives an object or a leaf node that is hit by a ray, from the TRV unit 120. The IST unit 130 reads information about primitives included in a hit object, from the external memory 250. Information about the read primitives may be stored in an IST cache. An IST cache denotes a memory to temporarily store data used by the IST unit 130 in an intersection test.

The IST unit 130 conducts an intersection test on an intersection point between a ray and a primitive to output a primitive hit by a ray and an intersection point. The IST unit 130 receives information about an object that is hit by a ray from the TRV unit 120. The IST unit 130 tests which of primitives are hit by a ray from among a plurality of primitives included in a hit object. The IST unit 130 searches for a primitive hit by a ray, and outputs an intersection point indicating which point of the hit primitive intersects the ray. The intersection point may be output to the shading unit 140 as coordinates.

The IST unit 130 may conduct an intersection test by using results of previous rendering. The IST unit 130 may initially conduct an intersection test on the same primitive as that of previous rendering based on results of previous rendering that are stored in the IST cache. When the IST unit 130 conducts an intersection test with respect to an input ray, the IST unit 130 may initially conduct an intersection test on a primitive hit by a previous ray having the same viewpoint and the same direction as the input ray.

The shading unit 140 determines a color value of a pixel based on information about an intersection point, received from the IST unit 130, and properties of a material of the intersection point. The shading unit 140 determines a color value of a pixel by considering a basic color of a material of the intersection point and effects due to a light source.

The shading unit 140 may generate a secondary ray based on material information with respect to an intersection point. As different phenomena such as reflection or refraction occur based on properties of a material, the shading unit 140 may generate a secondary ray such as a reflection ray or a refraction ray according to the properties of a material. Also, the shading unit 140 may generate a shadow ray based on a position of a light source.

The ray tracing core 100 receives data needed in ray tracing, from the external memory 250. An acceleration structure or geometry data is stored in the external memory 250. An acceleration structure is generated by the acceleration structure generating apparatus 200 and is stored in the external memory 250. Geometry data denotes information about primitives. A primitive may be a polygon such as a triangle or a rectangle, and geometry may indicate information about a vertex and a position of primitives included in an object.

The acceleration structure generating apparatus 200 generates an acceleration structure including position information about objects in 3D space. In other words, the acceleration structure generating apparatus 200 splits 3D space in a hierarchical tree structure. The acceleration structure generating apparatus 200 may generate various types of acceleration structures. For example, the acceleration structure generating apparatus 200 may generate an acceleration structure indicating a relationship between objects in 3D space by applying BVH or KD-tree. The acceleration structure generating apparatus 200 may determine a maximum number of primitives of a leaf node and a depth of tree and generate an acceleration structure based on the determined maximum number and the determined depth of tree.

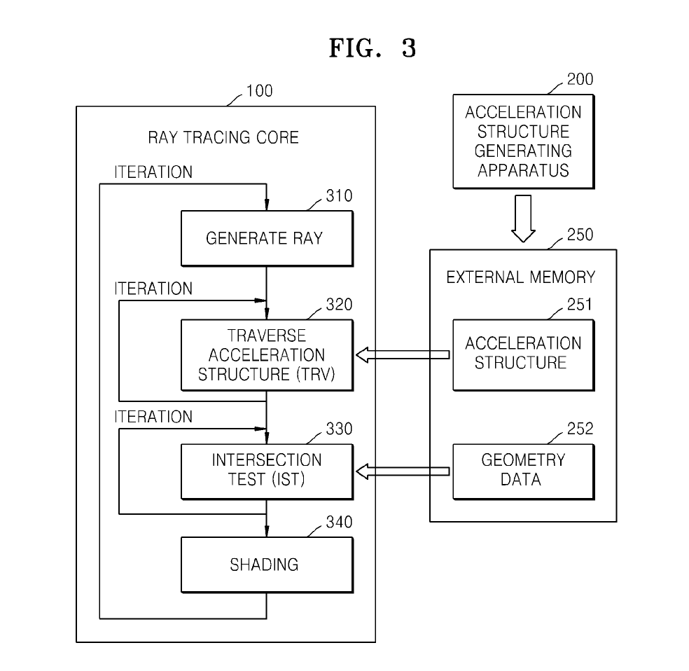

FIG. 3 is a diagram illustrating an example of ray tracing performed by the ray tracing core 100. The operations in FIG. 3 may be performed in the sequence and manner as shown, although the order of some operations may be changed or some of the operations omitted without departing from the spirit and scope of the illustrative examples described. Many of the operations shown in FIG. 3 may be performed in parallel or concurrently. FIG. 3 may also be described as a schematic view to explain an operation of the example ray tracing core 100 illustrated in FIG. 2. Accordingly, descriptions of the ray tracing core 100 also apply to ray tracing of FIG. 3, and will not be repeated here.

In operation 310, the ray tracing core 100 generates a ray. The ray tracing core 100 generates a primary ray, a secondary ray, and rays derived from the secondary ray.

In operation 320, the ray tracing core 100 traverses an acceleration structure 251. The acceleration structure 251 is read from the external memory 250. The ray tracing core 100 detects a bounding box hit by a ray, by traversing the acceleration structure 251 based on a viewpoint and a direction of generated rays. Also, the ray tracing core 100 detects an object hit by a ray from among objects included in the hit bounding box. The ray tracing core 100 repeats traversing the acceleration structure 251 until an object is hit. The ray tracing core 100 traverses an acceleration structure along a predetermined route, and when a leaf node on the searched route is not hit by a ray, the ray tracing core 100 traverses other routes in an acceleration structure.

The ray tracing core 100 may sequentially traverse all routes but may initially traverse a predetermined route based on search information of a previous ray. The ray tracing core 100 may search for a route in which a hit leaf node is included in a previous node when the previous ray has the same or similar viewpoint and the same or similar direction as a current ray.

In operation 330, the ray tracing core 100 conducts an intersection test. The ray tracing core 100 reads geometry data 252 of primitives from the external memory 250. The ray tracing core 100 conducts an intersection test based on the geometry data 252 that it read. The ray tracing core 100 iterates an intersection test until a hit primitive is detected. The ray tracing core 100 conducts an intersection test on a primitive, and when any primitive is hit by a ray, the ray tracing core 100 conducts an intersection test on another primitive.

The ray tracing core 100 may sequentially conduct an intersection test on all primitives but may also initially test a predetermined primitive based on information about an intersection test of a previous ray. The ray tracing core 100 may initially conduct an intersection test on a primitive that is hit by a previous ray when the previous ray and a current ray have the same or similar viewpoint and the same or similar direction.

In operation 340, the ray tracing core 100 conducts shading of a pixel based on the intersection test. After operation 340 is completed, the ray tracing core 100 returns to operation 310. The ray tracing core 100 iterates operations 310 through 340 with respect to all pixels that form an image.

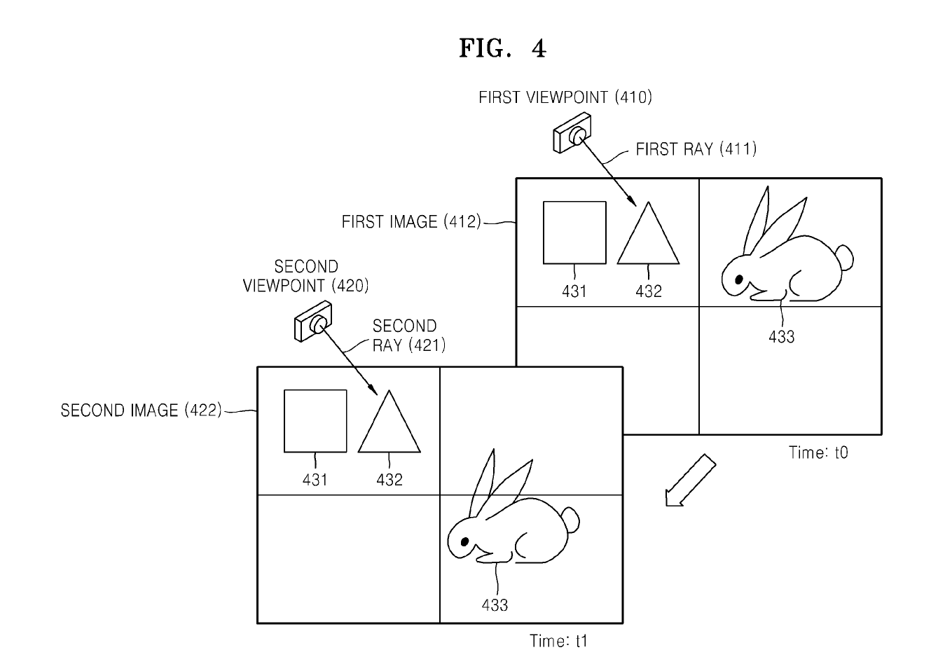

FIG. 4 is a diagram illustrating an example of a method of accelerating ray tracing. Referring to FIG. 4, a first image 412 is an image that is rendered at t=0, and a second image 422 is an image that is rendered at t=1. As only one object 433 has moved between the first image 412 and the second image 422, the first image 412 and the second image 422 are similar. Accordingly, the ray tracing core 100 may conduct rendering with respect to the second image 421 by using a result of rendering the first image 412. For example, when a first viewpoint 410 and a second viewpoint 420 are at the same position, and a first ray 411 and a second ray 421 are in the same direction, the ray tracing core 100 may accelerate ray tracing of the second ray 421 by applying a result of ray tracing of the first ray 411. The TRV unit 120 of the ray tracing core 100 may initially traverse a bounding box hit by the first ray 411 when conducting a search with respect to the second ray 421. The IST unit 130 of the ray tracing core 100 may preferentially conduct an intersection test on a triangle 432 hit by the first ray 411 during an intersection test with respect to the second ray.

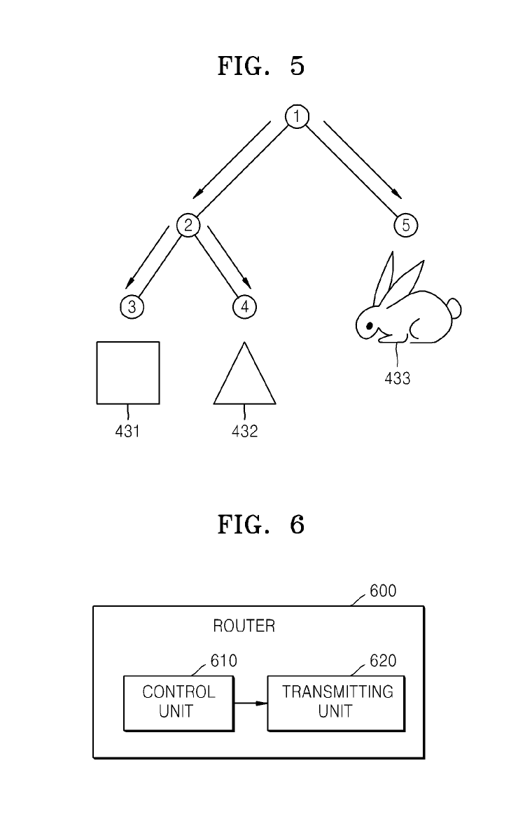

FIG. 5 is diagram illustrating an example of a method of accelerating ray tracing of FIG. 4. Referring to FIG. 5, an acceleration structure includes five nodes, node 1 through 5, and nodes 3 through 5 each denote a leaf node.

The TRV unit 120 may traverse an acceleration structure along three routes. First, the TRV unit 120 may traverse an acceleration structure along a first route, i.e., along node 1, node 2, and node 3. Secondly, the TRV unit 120 may traverse an acceleration structure along a second route, i.e., node 1, node 2, and node 4. Thirdly, the TRV unit 120 may traverse an acceleration structure along a third route, i.e., node 1 and node 5. When the TRV unit 120 conducts a search with respect to the second ray 421, the TRV unit 120 traverses the second route through which a triangle 432 hit by the first ray 411 is searched. Accordingly, the TRV unit 120 may omit an operation of traversing the first route or the third route.

FIG. 6 is a diagram illustrating an example of a router 600. The router 600 includes a control unit 610 and a transmitting unit 620. The router 600 transmits input data to rendering units for rendering input data. The router 600 may designate a routing path of input data by using a routing table, and may update a routing table based on the input data.

The control unit 610 identifies a group of input data. For example, a group ID indicating a group to which data belongs is included in the data. Accordingly, the control unit 610 may identify a group of data by identifying the group ID included in the data.

A group ID is assigned to data based on properties of data, by using a data generating unit. For example, when generating ray data by using a ray generating unit, a group of rays may be determined based on a viewpoint and a direction of a ray. Rays having similar viewpoints and similar directions may be classified in the same group. Similar rays have a viewpoint within an area or a section of a predetermined size and an angle within a preset range.

Data may be ray data for ray tracing. Ray data may be a primary or secondary ray. Ray data includes information about a viewpoint and a direction of a ray.

In another example, data may be rendering data for ray tracing. Rendering data includes information about an acceleration structure or information about an object located in 3D space or the like. Rendering data is stored in an internal memory or a cache or the like included in a TRV unit or an IST unit.

The control unit 610 updates a routing path designated for an identified group based on a feedback signal with respect to data. The control unit 610 updates a routing path based on paths through which feedback signals regarding data of the same group are transmitted and information included in the feedback signals, wherein the feedback signals are transmitted from processing units that have received the data of same group.

The control unit 610 receives a feedback signal and identifies a path through which the feedback signal is transmitted. A path through which a feedback signal is transmitted may be information used to distinguish a processing unit that has transmitted the feedback signal, from among a plurality of processing units.

The control unit 610 identifies information included in a feedback signal. Information included in a feedback signal may be information indicating whether a processing unit that has received data has used the data.

The control unit 610 updates a routing path based on information regarding the processing unit from which a feedback signal is received and information about whether a processing unit that has transmitted a feedback signal has used data.

The control unit 610 updates a routing path to a path having a highest probability that a feedback signal, including a hit result, has been transmitted, from among feedback signals with respect to data of the same group. When a processing unit that has received data and has used the data, the processing unit transmits a feedback signal, including a hit result, to the router 600. When the processing unit that has received data has not used the data, the processing unit transmits a feedback signal, including a miss result, to the router 600. The control unit 610 updates a routing path of data to a processing unit with a highest probability of transmitting a feedback signal, including a hit result, from among feedback signals transmitted by a plurality of processing units. The control unit 610 updates a routing path of a group in which data is included, by considering all feedback signals with respect to data of the same group.

In another example, the control unit 610 updates a routing path to a TRV unit or an IST unit to which a feedback signal, including a hit result, has been most recently transmitted, from among feedback signals with respect to ray data of the same group. That is, the control unit 610 identifies a TRV unit or an IST unit by using ray data included in the same group as that of input ray data, and updates a routing path by using information indicating the identified TRV unit or the identified IST unit.

In the case of ray tracing, a processing unit may be, for example, a ray generating unit, a TRV unit, an IST unit, or a shading unit. In the case of a 3D graphic application programming interface (API) such as Open Graphics Library (OpenGL), a processing unit may be, for example, a vertex shader, a primitive generator, a raster, or a pixel shader.

The transmitting unit 620 transmits data via a routing path designated for the identified group. The transmitting unit 620 transmits data via a path designated for a group in which the data is included, by referring to the routing path. For example, a routing path may indicate a processing unit designated for each group, and the transmitting unit 620 transmits data to the designated processing unit. When there is no designated path for an identified group, the transmitting unit 620 broadcasts to all processing units. Also, when multiple paths are designated for an identified group, the transmitting unit 620 multicasts to a plurality of processing units.

In the case of ray tracing, the transmitting unit 620 transmits ray data to a TRV unit or an IST unit designated as a routing path. The transmitting unit 620 identifies a group of input ray data, and transmits ray data via a routing path designated for the identified group. For example, a routing path indicates a TRV unit or an IST unit that is designated to a group to which input ray data belongs.

In the case of ray tracing, a data group is assigned to data based on a viewpoint and a direction of a ray. A data group is identified by inserting information with which a group may be identified, into data.

The transmitting unit 620 transmits data to a processing unit that is set as a TRV unit or an IST unit. When data input to the router 600 is initial ray data from among data included in a group in which data is included, the transmitting unit 620 transmits input ray data to all TRV units or all IST units. When a routing route for a group including input ray data is not designated, the transmitting unit 620 transmits input ray data to a processing unit which is a TRV unit or an IST unit.

When there is information indicating a result of intersection point with respect to another data included in a data group, the transmitting unit 620 transmits data to a TRV unit or an IST unit based on the intersection result. When the router 600 has transmitted another ray data included in a group of input ray data to a TRV unit or an IST unit, and has received a feedback signal, including a hit result, from a TRV unit or an IST unit, the router 600 transmits input ray data to a TRV unit or an IST unit that has transmitted the feedback signal, including a hit result.

FIG. 7 is a diagram illustrating an example of a router 600. Referring to FIG. 7, the router 600 determines a routing path of input data by referring to a routing table 710.

The router 600 transmits or receives a feedback signal. The router 600 identifies a data group, and transmits data via a path designated for the data group by referring to the routing table 710. Also, the router 600 may receive a feedback signal and update the routing table 710 based on the feedback signal. A feedback signal may include results such as hits or misses. A hit indicates that data is used by a processing unit that transmits a feedback signal. A miss indicates that data is not used by a processing unit that transmits a feedback signal.

The router 600 is connected to a processing unit 700. The router 600 may output input data to the processing unit 700 or receive data from the processing unit 700.

When the router 600 has received data of Group 1, the router 600 transmits data of Group 1 to East. That is, East of the routing table 710 is designated as a routing path for data of Group 1. The router 600 may update a routing path with respect to Group 1 based on a feedback signal with respect to data that is transmitted to East.

Also, when the router 600 has received data of Group 2, the router 600 transmits data of Group 2 in all directions by referring to the routing table 710. That is, default of the routing table 710 is designated as a routing path for data of Group 2. Accordingly, the router 600 transmits data of Group 2 in all directions. In another example, the router 600 transmits data of Group 2 in any one direction.

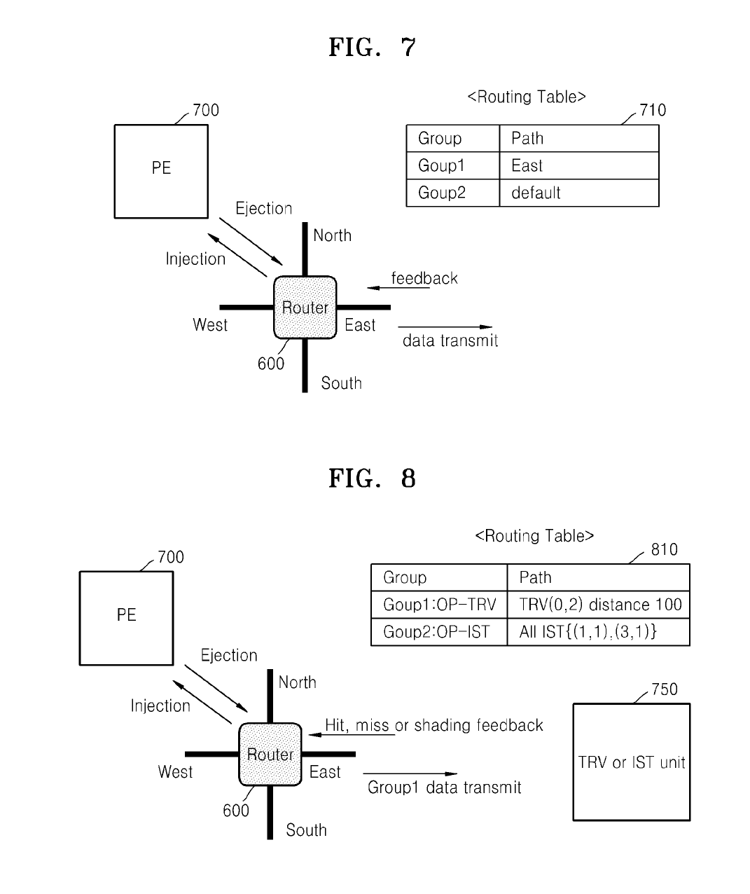

FIG. 8 is a diagram illustrating an example of a router 600. Referring to FIG. 8, the router 600 determines a routing path of input ray data by referring to a routing table 810.

The router 600 transmits ray data or receives a feedback signal. The router 600 identifies a group of ray data, and transmits input ray data to a path designated for a group of the ray data by referring to the routing table 810. The router 600 may transmit ray data to a TRV or IST unit 750.

Also, the router 600 may receive a feedback signal with respect to the transmitted ray data, and update the routing table 810 based on the feedback signal. A feedback signal may include at least one result such as a hit, a miss, or a shading. A hit indicates that the TRV or IST unit 750 that transmits a feedback signal has conducted intersection or traversal using ray data. A miss indicates that the TRV or IST unit 750 that transmits a feedback signal has not conducted intersection test or traversal using ray data. A shading indicates that the TRV or IST unit 750 that transmits a feedback signal has conducted shading using ray data.

The router 600 is connected to the processing unit 700. The router 600 may output input ray data to the processing unit 700 or receive ray data from the processing unit 700.

When the router 600 receives data of Group 1, the router 600 transmits the data of Group 1 to a TRV unit that has position information at (0, 2) and distance information of 100 by referring to the routing table 810. That is, a TRV unit having position information of (0, 2) and distance information of 100, of the routing table 810, is designated as a routing path for the data of Group 1. The router 600 may update the routing path for Group 1 based on a feedback signal with respect to data that is transmitted to the TRV unit having position information of (0, 2) and distance information of 100. A TRV unit having position information of (0, 2) and distance information of 100 indicates that a processing unit at a position (0, 2) is assigned as the TRV unit. Also, a TRV unit having distance information of 100 indicates a TRV unit that includes information of a node that is at a distance of 100 from a viewpoint of a ray.

Also, when the router 600 has received ray data of Group 2, the router 600 transmits the ray data of Group 2 to IST units having position information (1, 1) and (3, 1) by referring to the routing table 810. That is, a routing path of the ray data of Group 2 is designated as IST units of the routing table 810 having position information of (1, 1) and (3, 1). Accordingly, the router 600 transmits the data of Group 2 to the IST units having position information of (1, 1) and (3, 1).

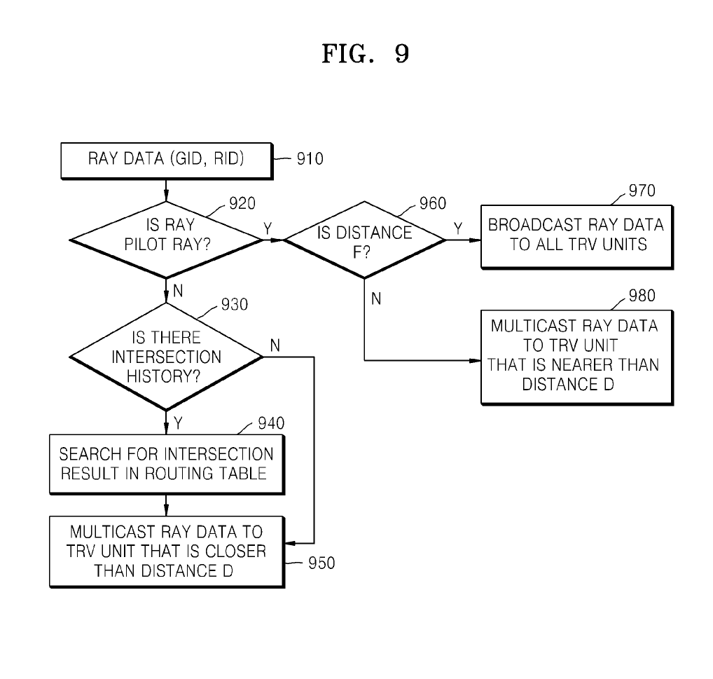

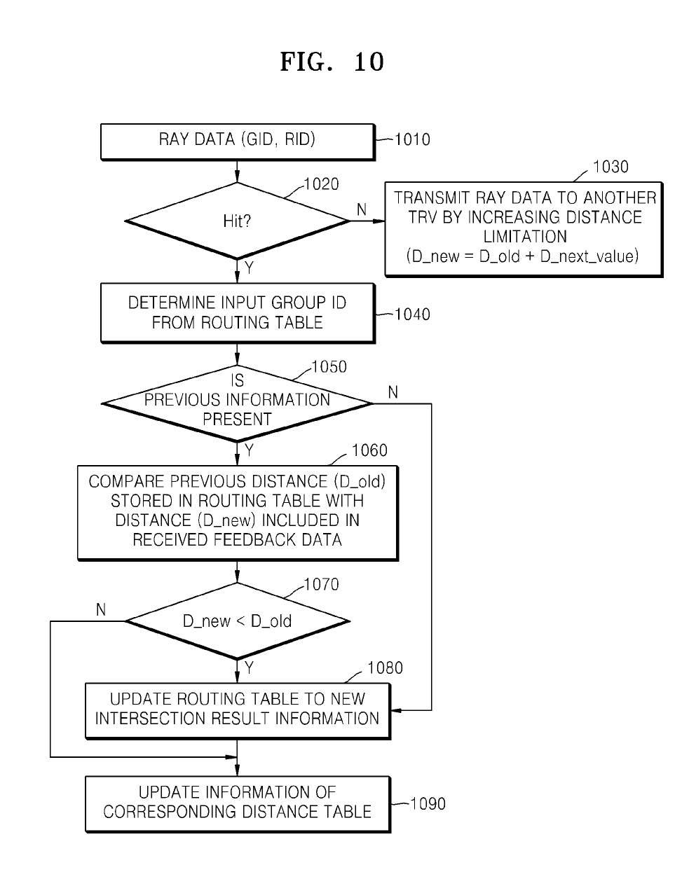

FIG. 9 is a diagram illustrating an example of a method of routing ray data, performed by the router 600 of FIG. 6. The operations in FIG. 9 may be performed in the sequence and manner as shown, although the order of some operations may be changed or some of the operations omitted without departing from the spirit and scope of the illustrative examples described. Many of the operations shown in FIG. 9 may be performed in parallel or concurrently. Referring to FIG. 9, the router 600 transmits ray data by referring to intersection history.

In operation 910, the router 600 receives ray data. Ray data includes ray group information GID and ray information RID. The ray group information GID is assigned to ray data before it is input to the router 600. The ray group information GID may be assigned by a data manager included in a ray tracing core when a ray is generated. In other words, when a ray is generated, a data manager determines a group of rays generated based on a viewpoint and a direction of the generated ray. A data manager may assign a group ID indicating a group determined for the generated ray. The ray information RID includes information about a viewpoint and a direction of a ray and information indicating an order of a pixel and an order of a frame to which a ray belongs. Also, the ray information RID may include information about whether a ray is a primary ray or a secondary ray, and when the ray is a secondary ray, the ray information RID may include information indicating whether a secondary ray is a reflection ray, a refraction ray, or a shadow ray. Also, ray data may include information indicating whether a ray is a pilot ray. A pilot ray indicates an initial ray, and when a ray is a pilot ray, routing is conducted without using previous intersection history.

In operation 920, the router 600 determines whether input ray data is a pilot ray. If the ray data is a pilot ray, the method proceeds to operation 960, otherwise the method proceeds to operation 930.

In operation 930, the router 600 determines whether there is intersection history of ray data. The router 600 determines whether there is intersection history regarding a group ID of ray data. When there is intersection history of ray data, the method proceeds to operation 940, and otherwise the method proceeds to operation 950.

In operation 940, the router 600 traverses an intersection result of a group ID of ray data in a routing table. Paths of respective group IDs are stored in the routing table. Pocessing units and distances D with respect to group IDs are stored in the routing table.

In operation 950, the router 600 multicasts to a TRV unit or an IST unit that is closer than a distance D. A TRV unit or an IST unit that is closer than a distance D includes information about a node that is closer than a distance D from a viewpoint of a ray.

If there is intersection history about input ray data, multicasting is performed based on distance information with respect to a group ID stored in a routing table. When distance information D is stored in a routing table, the router 600 multicasts ray data based on distance D.

If there is no intersection history with respect to input ray data, the ray data is multicast based on distance information stored in the ray data. In other words, when distance information D is stored in ray data, the router 600 multicasts ray data based on the distance information D.

In operation 960, the router 600 determines whether there is no limitation in distance, i.e., distance information with respect to ray data is F. If all distance information is F, the method proceeds to operation 970, otherwise the method proceeds to operation 980.

In operation 970, the router 600 broadcasts ray data to all TRV units or all IST units. As there is no distance limitation to ray data, and the ray data is a pilot ray, the router 600 broadcasts ray data to all TRV units or IST units.

In operation 980, the router 600 multicasts ray data to TRV units or IST units that are closer than distance D. Although ray data is a pilot ray, since there is a distance limitation, the router 600 multicasts ray data only to a TRV unit or an IST unit that satisfies the distance limitation.

FIG. 10 is a diagram illustrating an example of an operation of updating a routing table, performed by the router 600. The operations in FIG. 10 may be performed in the sequence and manner as shown, although the order of some operations may be changed or some of the operations omitted without departing from the spirit and scope of the illustrative examples described. Many of the operations shown in FIG. 10 may be performed in parallel or concurrently. Referring to FIG. 10, the router 600 updates routing table based on feedback data.

In operation 1010, the router 600 receives feedback data. Feedback data includes ray group information GID and ray information RID. In other words, feedback data includes information about the rays and ray groups that are related.

In addition, feedback data includes information about whether ray data is used or not. When ray data is used in intersection or traversal, feedback data includes a hit result. When ray data is not used in intersection or traversal, feedback data includes a miss result. When ray data is used in shading, feedback data includes a shading result.

In operation 1020, the router 600 determines whether a hit result is included in feedback data. If a hit result is included, the method proceeds to operation 1040, otherwise the method proceeds to operation 1030.

In operation 1030, the router 600 transmits ray data to another TRV unit or another IST unit by increasing the distance limitation by one more step. As ray data transmitted by the router 600 is not used by a TRV unit or an IST unit within a distance D_old, the router 600 transmits ray data to a TRV unit or an IST unit that is at a distance exceeding the distance D_old. The router 600 determines a value obtained by adding D_old and D_next_value as D_new, and transmits ray data to a TRV unit or an IST unit including distance information D_new. D_new_value is a value having a preset amount.

In operation 1040, the router 600 searches a routing table for a group ID included in feedback data. The router 600 identifies a group ID included in feedback data to determine which group of rays is the feedback data related to. The router 600 inquires about information about an identified group ID in the routing table.

In operation 1050, the router 600 determines whether there is information about an identified group ID in the routing table. If there is information about an identified group ID in a routing table, the method proceeds to operation 1060, otherwise the method proceeds to operation 1080.

In operation 1060, the router 600 compares a previous distance D_old stored in the routing table and a distance D_new included in the received feedback data.

In operation 1070, the router 600 determines whether or not the distance D_new is less than the previous distance D_old. If the distance D_new is less than the previous distance D_old, the method proceeds to operation 1080, otherwise the method proceeds to operation 1090.

In operation 1080, the router 600 updates a routing table based on a new intersection result. The router 600 updates group ID information of feedback data of the routing table to include a hit TRV unit or a hit IST unit.

In operation 1090, the router 600 updates a distance table with information of a group ID of feedback data. The router 600 updates the previous distance D_old stored in the routing table to the distance D_new.

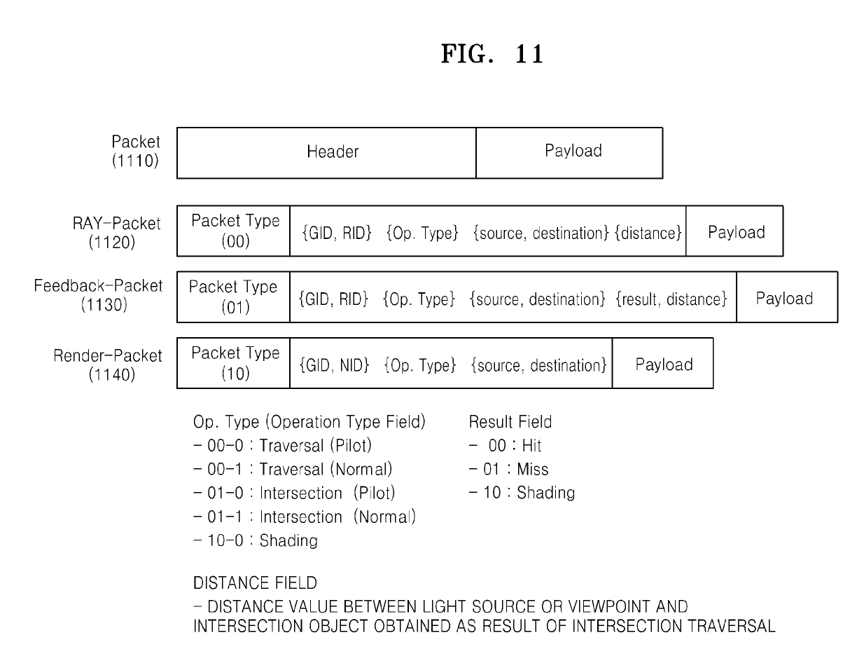

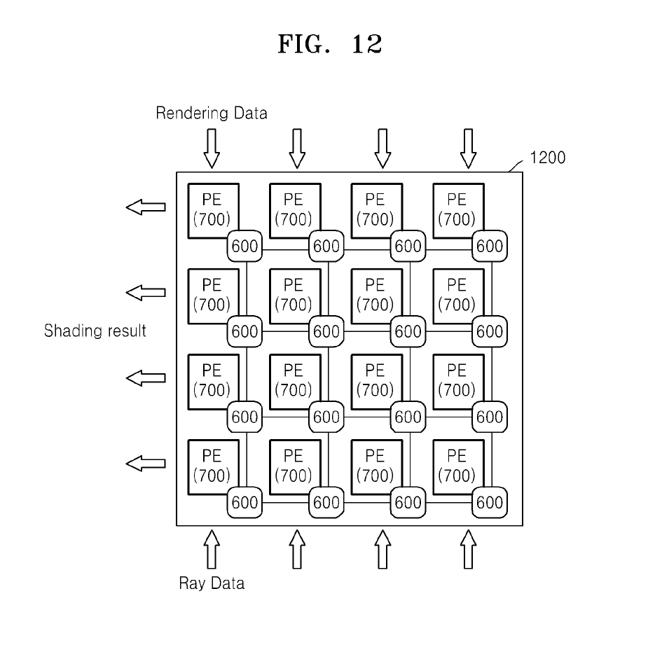

FIG. 11 is a diagram illustrating an example of packets that are transmitted or received using the router 600. Referring to FIG. 11, a packet 1110 includes a header and a payload. The header includes information to identify the packet 1110, and the payload includes information indicating contents of the packet 1110.

A ray packet 1120, a feedback packet 1130, and a render packet 1140 include a packet type field, a ray field, an operation type field, a routing path field, and a distance field. The feedback packet 1130 further includes a result field.

The packet type field indicates that a corresponding packet is one of a ray packet, a feedback packet, or a render packet. For example, a ray packet is expressed as 00, and a feedback packet is expressed as 01, and a render packet is expressed as 10.

The ray field indicates which ray is relevant. For example, a ray field may include a group ID (GID) indicating a ray group and a ray ID (RID) for identifying a ray.

The operation type field includes processing information about a ray. The operation type field includes information on whether a ray is to be transmitted to a TRV unit or an IST unit. Also, the operation type field includes information on whether a ray is to be processed as a pilot ray or a normal ray. For example, when an operation type field is 00-0, a ray packet is transmitted to a TRV unit and is processed as a pilot ray. When an operation type field is 00-1, a ray packet is transmitted to a TRV unit and is processed as a normal ray. When an operation type field is 01-0, a ray packet is transmitted to an IST unit and is processed as a pilot ray. When an operation type field is 01-1, a ray packet is transmitted to an IST unit and is processed as a normal ray. When an operation type field is 10-0, a render packet is transmitted to a shading unit and is shaded.

The routing path field includes information about a source and a destination of a packet's transmission. The source indicates a router or a processing unit that transmits a packet. A target indicates a router or a processing unit that receives a packet.

The distance field indicates a distance between a light source or a viewpoint of rays and an intersection object. When a distance value is stored in a distance field, the router 600 transmits a packet to a processing unit that has a smaller distance value than the above distance value.

The result field is included in the feedback packet 1130 and includes information on whether data is used or not. For example, when a value of a result field is 00, it means that ray data has been used. In other words, it means that ray data is intersected or used in a TRV unit or an IST unit. When a result field is 01, it means that ray data is not used. In other words, it means that ray data is not intersected or used in a TRV unit or an IST unit. When a result field is 11, it means that ray data is shaded.

FIG. 12 is a diagram illustrating an example of a Network-on-Chip (NoC) 1200. The NoC 1200 includes a plurality of processing units 700 and a plurality of routers 600.

The processing units 700 may be configured as units that conduct various operations. For example, the processing units 700 may be a ray generating unit, a TRV unit, an IST unit, or a shading unit. The processing units 700 may be referred to as a function unit. The processing units 700 and the routers 600 are connected, and one processing unit 700 and one router 600 form a pair.

The NoC 1200 transmits ray data and rendering data to a processing unit with a high intersection possibility. Ray data and rendering data are input to the router 600, and the router 600 transmits ray data and rendering data to the processing units 700 based on information included in the ray data, rendering data, and information stored in a routing table. The router 600 determines a processing unit 700 that is to process ray data or rendering data when ray data or rendering data is input, and transmits the ray data and the rendering data to the determined processing unit 700.

While rendering units are not allocated to the processing units 700 in FIG. 12, rendering units may be allocated to the processing units 700 based on a workload. The processing units 700 included in the NoC 1200 may be set as rendering units.

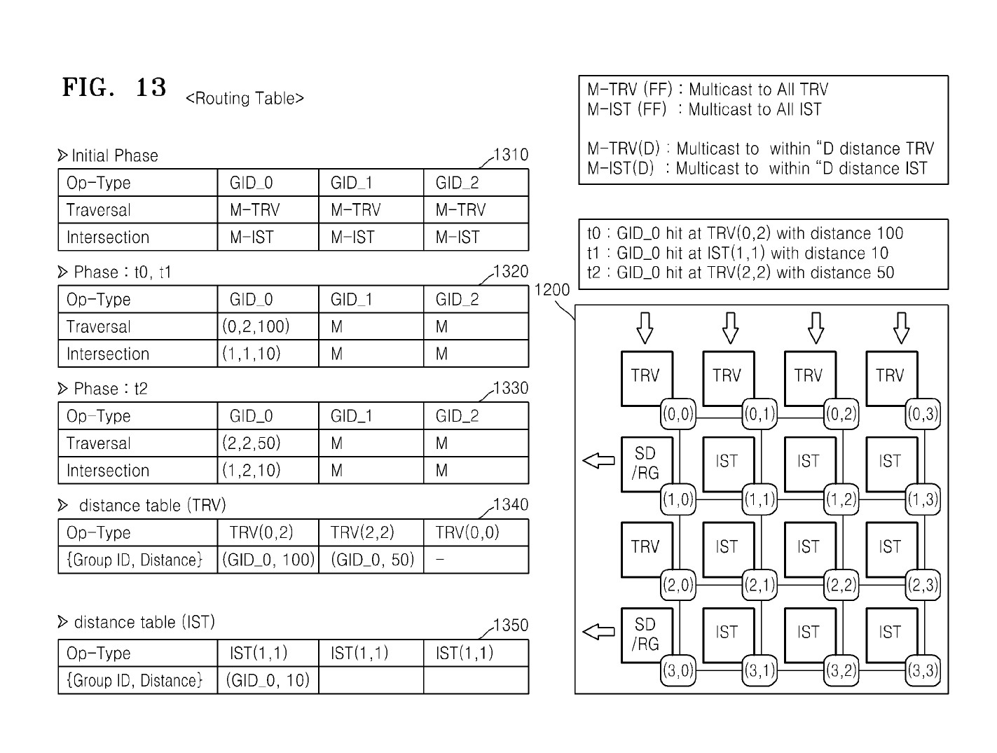

FIG. 13 is a diagram illustrating an example of a routing table. Referring to FIG. 13, the routing table includes first through fifth tables 1310 through 1350.

The first table 1310 indicates an initial state. The Op-Type of GID_{—}0, GID_{—}1, or GID_{—}2 indicates a group ID. As there is no intersection information for the first table 1310, all groups are assigned either as M-TRV or M-IST. Accordingly, in the initial state, routing may be determined according to input ray data. For example, M-TRV(FF) indicates broadcasting input ray data to all TRV units, M-IST(FF) indicates broadcasting input ray data to all IST units. M-TRV(D) indicates broadcasting input ray data to TRV units whose distance is equal to or less than distance D, and M-IST(D) indicates broadcasting input ray data to IST units whose distance is equal to or less than distance D. Distance information is the same as that described with reference to FIG. 11.

The second and third tables 1320 and 1330 show changes with time. When t=0, and a ray with a group ID GID_{—}0 has hit a TRV unit at (0,2) at a distance of 100, a traversal field of group GID_{—}0 of the second table 1320 is updated. In the second table 1320, a traversal field of group GID_{—}0 is updated. (0, 2, 100) that is stored at GID_{—}0 of the second table 1320 indicates a position (0,2) of a TRV unit, and (100) indicates distance information of a hit TRV unit.

When t=1 and a ray with a group ID GID_{—}0 has hit an IST unit at (1, 1) and at a distance of 10, an intersection field of group GID_{—}0 in the second table 1320 is updated. (1, 1, 10) stored in GID_{—}0 of the second table 1320 denotes a position (1, 1) of an IST unit, and (10) denotes distance information of a hit IST unit.

When t=2 and a ray with a group ID GID_{—}0 has hit a TRV unit at (2,2) and at a distance of 50, an intersection field of group GID_{—}0 in the third table 1330 is updated. In the third table 1330, (0, 2, 100) stored in a traversal field of group GID_{—}0 is removed, and (2, 2, 50) is stored.

When t=2 and a ray with a group ID GID_{—}0 has hit an IST unit at (1,2) and at a distance of 10, an intersection field of group GID_{—}0 is updated in the third table 1330. In the third table 1330, (1, 1, 10) stored in an intersection field of group GID_{—}0 is removed, and (1,2,10) is stored.

The fourth table 1340 denotes information about a ray hit by TRV units. For example, (GID_{—}0,100) is stored in a TRV(0,2) field of the fourth table 1340. That is, the TRV unit at (0,2) denotes that a ray having a group ID GID_{—}0 is hit at a distance of 100. As another example, (GID_{—}0, 50) is stored in a TRV(2,2) field of the fourth table 1340. That is, the TRV unit at (2,2) denotes that a ray having a group ID GID_{—}0 is hit at a distance of 50.

The fifth table 1350 denotes information about a ray hit by IST units. For example, in an IST (1, 1) field of the fifth table 1350, (GID_{—}0, 10) is stored. That is, an IST unit located at (1, 1) denotes that a ray having a group ID GID_{—}0 is hit at a distance of 10.

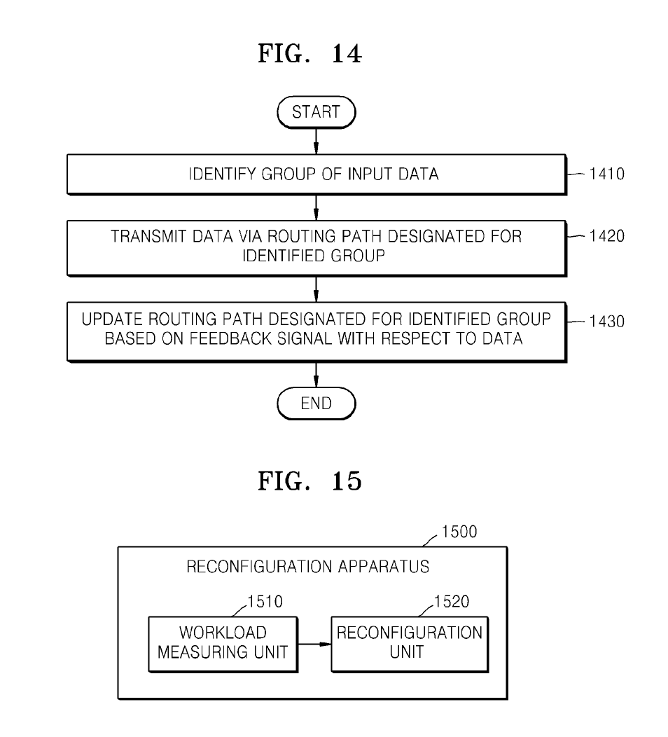

FIG. 14 is a diagram illustrating an example of a routing method. The descriptions of the router 600 also applies to the routing method of FIG. 14, and thus will not be repeated here. The operations in FIG. 14 may be performed in the sequence and manner as shown, although the order of some operations may be changed or some of the operations omitted without departing from the spirit and scope of the illustrative examples described. Many of the operations shown in FIG. 14 may be performed in parallel or concurrently.

The router 600 performs operations 1410 through 1430 to designate a routing path of data of the same group as input data.

In operation 1410, the control unit 610 of the router 600 identifies a group of input data. Data includes a field indicating a group, and the control unit 610 may identify a data group by reading a field value indicating a group.

In operation 1420, the transmitting unit 620 of the router 600 transmits data to a routing path designated for an identified group. The router 600 includes a routing table in which routing paths are stored for respective groups. Accordingly, the transmitting unit 620 searches a routing path for the identified group, in a routing table, and transmits data via a found routing path.

In operation 1430, the control unit 610 of the router 600 updates a routing path designated to the identified group based on a feedback signal with respect to data. The control unit 610 receives a feedback signal, and updates a routing path by referring to fields included in the feedback signal. The control unit 610 identifies a group to which a feedback signal is related to, and identifies a result regarding the data. The control unit 610 updates a routing path of the identified group based on a result of identification.

FIG. 15 is a diagram illustrating an example of a reconfiguration apparatus 1500. The reconfiguration apparatus 1500 includes a workload measurement unit 1510 and a reconfiguration unit 1520.

The reconfiguration apparatus 1500 reconfigures rendering units for rendering of a current frame based on a workload measured during rendering of a previous frame. The workloads of rendering units differ according to characteristics of frames. Thus, to increase the total rendering efficiency, the workloads of the rendering units are predicted, and the rendering units may be dynamically allocated to processing units based on the result of the prediction.

The workload measuring unit 1510 measures workloads of rendering units used to render a previous frame. The rendering units include at least one of a ray generating unit, a TRV unit, an IST unit, and a shading unit used in ray tracing. The workloads of the rendering units indicate a computation conducted by the rendering units during rendering of a previous frame. The workload measuring unit 1510 measures a computation conducted by a ray generating unit, a TRV unit, an IST unit, or a shading unit during rendering of a previous frame.

The workload measuring unit 1510 may calculate the workloads of the rendering units by measuring a degree of reflection or refraction based on a structure of an object included in 3D space and material characteristics of an object.

The reconfiguration unit 1520 reconfigures the rendering units during rendering of a current frame based on the measured workload of a previous frame. The reconfiguration unit 1520 allocates the rendering units by considering balance of the workloads of the rendering units. For example, the reconfiguration unit 1520 may reconfigure or allocate the rendering units such that a difference between the workloads of the rendering units is the smallest. In other words, the reconfiguration unit 1520 reconfigures the rendering units such that a difference in computations of the rendering units is the smallest by considering a computation measured from a previous frame for each of the rendering units.

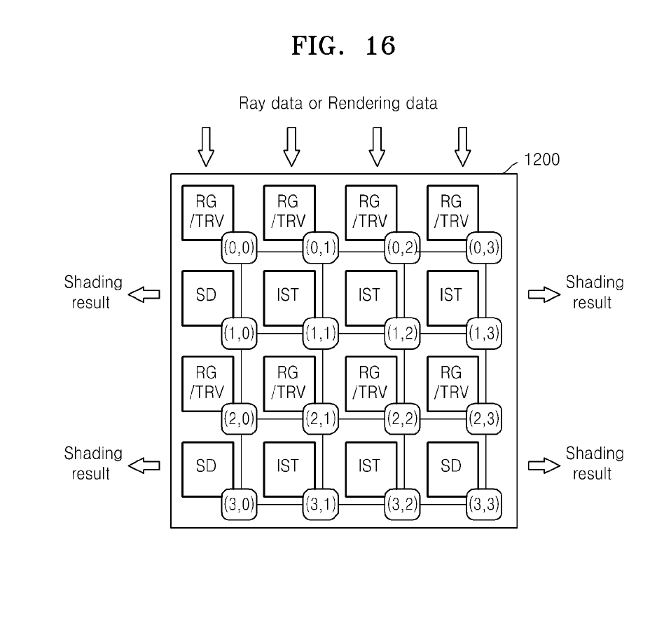

FIG. 16 is a diagram illustrating example of rendering units assigned to processing units. Referring to FIG. 16, the reconfiguration apparatus 1500 allocates rendering units to processing units according to characteristics of a ray.

When performing rendering with respect to a primary ray during ray tracing, the reconfiguration unit 1520 allocates a ray generating unit and a TRV unit to a single processing unit. For a primary ray, rather than generating ray data by using a ray generating unit and transmitting the generated ray data to a TRV unit, generating a ray and traversing an acceleration structure by using a single processing unit is more efficient. Thus, the reconfiguration unit 1520 allocates a ray generating unit and a TRV unit to a single processing unit. For example, a ray generating unit and a TRV unit are allocated to a processing unit from (0,0) to (0,3) or a processing unit at (2,0) to (2,3).

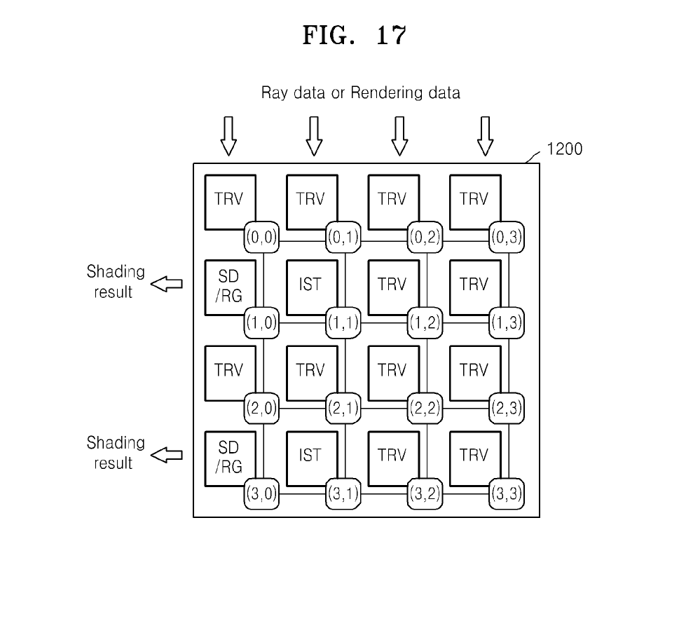

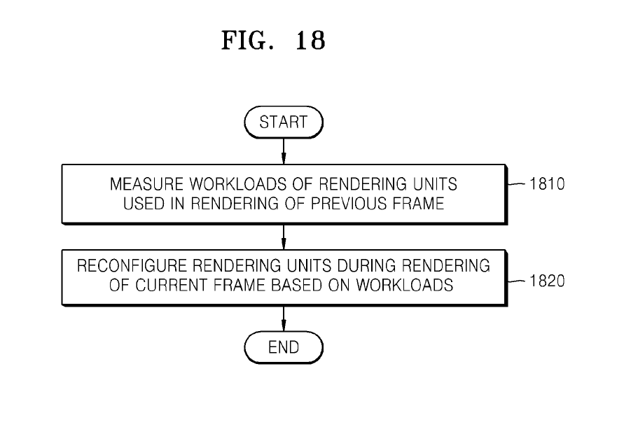

FIG. 17 is a diagram illustrating examples of rendering units assigned to processing units. FIG. 17 illustrates an example of processing units that are reconfigurable when an amount of workload of a TRV unit is large.

When performing rendering with respect to a secondary ray during ray tracing, a secondary ray is generated by refraction or reflection according to a shading result at an intersection with respect to a primary ray. Thus, the reconfiguration unit 1520 allocates a shading unit and a ray generating unit to a single processing unit. The number of secondary rays is greater than the number of primary rays, and thus, a TRV unit that traverses an acceleration structure has a greater workload. When performing rendering of a secondary ray, the reconfiguration unit 1520 allocates more TRV units to processing units than when performing rendering of a primary ray.

FIG. 18 is a diagram illustrating an example of a reconfiguring method of rendering units. The operations in FIG. 18 may be performed in the sequence and manner as shown, although the order of some operations may be changed or some of the operations omitted without departing from the spirit and scope of the illustrative examples described. Many of the operations shown in FIG. 18 may be performed in parallel or concurrently. FIG. 18 illustrates an operation of the reconfiguration apparatus 1500 of FIG. 15. Thus, descriptions of the reconfiguration apparatus 1500 also apply to the reconfiguration method of rendering units of FIG. 18, and will not be repeated here.

In operation 1810, the workload measuring unit 1510 measures workloads of rendering units used in rendering of a previous frame. The workload measuring unit 1510 may measure the workloads of the rendering units based on a type of ray used for rendering of a previous frame.

In operation 1820, the reconfiguration unit 1520 reconfigures rendering units during rendering of a current frame based on the measured workload. The reconfiguration unit 1520 determines the number of rendering units according to a type of ray, and allocates rendering units in the determined number to processing units. The reconfiguration unit 1520 may allocate rendering units having a relatively large workload to more processing units.

As described above, according to the examples illustrated, data of the same group may be transmitted via the same route, thereby increasing routing efficiency. A route of data that is in the same group as transmitted data may be updated based on a feedback signal received via the transmitted data. Ray data of the same group may be transmitted to the same TRV unit, thereby increasing a hit rate of ray data. Rendering units may be assigned to processing units by considering a workload measured during rendering of a previous frame, thereby performing rendering by distributing a workload of a current frame.

The processes, functions, and methods described above can be written as a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device that is capable of providing instructions or data to or being interpreted by the processing device. The software also may be distributed over network coupled computer systems so that the software is stored and executed in a distributed fashion. In particular, the software and data may be stored by one or more non-transitory computer readable recording mediums. The non-transitory computer readable recording medium may include any data storage device that can store data that can be thereafter read by a computer system or processing device. Examples of the non-transitory computer readable recording medium include read-only memory (ROM), random-access memory (RAM), Compact Disc Read-only Memory (CD-ROMs), magnetic tapes, USBs, floppy disks, hard disks, optical recording media (e.g., CD-ROMs, or DVDs), and PC interfaces (e.g., PCI, PCI-express, WiFi, etc.). In addition, functional programs, codes, and code segments for accomplishing the example disclosed herein can be construed by programmers skilled in the art based on the flow diagrams and block diagrams of the figures and their corresponding descriptions as provided herein.

The apparatuses and units described herein may be implemented using hardware components. The hardware components may include, for example, controllers, sensors, processors, generators, drivers, and other equivalent electronic components. The hardware components may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The hardware components may run an operating system (OS) and one or more software applications that run on the OS. The hardware components also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a hardware component may include multiple processors or a processor and a controller. In addition, different processing configurations are possible, such a parallel processors.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A routing method comprising:
identifying, at a processor, a group of input data;
transmitting the input data through a designated routing path; and
updating the routing path based on a feedback signal corresponding to the transmitted data.

2. The method of claim 1, wherein the updating of the routing path comprises updating the routing path based on paths through which feedback signals of the group are transmitted and information included in the feedback signals.

3. The method of claim 1, wherein:
the input data is ray data for ray tracing,
the transmitting of the ray data comprises transmitting the ray data to a traversal (TRV) unit or an intersection test (IST) unit designated to the routing path, and
the updating of the routing path comprises updating the routing path to a TRV unit or an IST unit from where a feedback signal indicating a most recent hit result is transmitted from ray data of the group.

4. The method of claim 1, wherein:
the input data is ray data for ray tracing,
the transmitting of the ray data comprises transmitting the ray data to a traversal (TRV) unit or an intersection test (IST) unit, and
the updating of the routing path comprises updating the routing path to a path through which a feedback signal indicating a hit result is most likely transmitted from ray data of the same group.

5. The method of claim 1, wherein the input data includes at least one of information on rays generated for ray tracing or information for rendering, and the group is assigned to the data based on a viewpoint and a direction of the rays.

6. The method of claim 1, wherein the input data includes information about the rays generated for ray tracing, and
the transmitting of the input data comprises transmitting the input data, to a processing unit set as a traversal (TRV) unit or an intersection test (IST) unit.

7. The method of claim 1, wherein in response to initial ray data being included in the group of the input data, the transmitting of the input data comprises transmitting the initial ray data to all traversal (TRV) units or to all intersection test (IST) units.

8. The method of claim 1, wherein in response to information indicating presence of an intersection result regarding another data being included in the group of the input data, the transmitting of the input data comprises transmitting the data to a traversal (TRV) unit or an intersection test (IST) unit based on the intersection result.

9. A non-transitory computer-readable recording medium having embodied thereon a program for executing the method of claim 1 on a computer.

10. A router comprising:
a controller configured to identify a group of input data; and
a transmitter configured to transmit the input data through a designated routing path,
wherein the controller is further configured to update the routing path based on a feedback signal corresponding to the transmitted data.

11. The router of claim 10, wherein the controller is further configured to update the routing path based on paths through which feedback signals of the group are transmitted and information included in the feedback signals.

12. The router of claim 10, wherein the input data is ray data for ray tracing, and
the transmitter is further configured to transmit the ray data to a traversal (TRV) unit or an intersection test (IST) unit designated to the routing path, and
the controller is further configured to update the routing path to a TRV unit or an IST unit from where a feedback signal indicating a most recent hit result is transmitted from ray data of the group.

13. The router of claim 10, wherein the input data is ray data for ray tracing, and
the transmitter is further configured to transmit the ray data to a traversal (TRV) unit or an intersection test (IST) unit, and
the controller is further configured to update the routing path to a path through which a feedback signal indicating a hit result is most likely transmitted from ray data of the same group.

14. The router of claim 10, wherein the input data includes at least one of information on rays generated for ray tracing or information for rendering, and the group is assigned to the data based on a viewpoint and a direction of the rays.

15. The router of claim 10, wherein the input data includes information about the rays generated for ray tracing, and the transmitter is further configured to transmit the data to a processing unit set as a traversal (TRV) unit or an intersection test (IST) unit.

16. The router of claim 10, wherein in response to the initial ray data being included in the group of the input data, the transmitter is further configured to transmit the initial ray data to all traversal (TRV) units or to all intersection test (IST) units.

17. The router of claim 10, wherein in response to information indicating presence of an intersection result regarding another data being included in the group of the input data, the transmitter is further configured to transmits the data to a traversal (TRV) unit or an intersection test (IST) unit based on the intersection result.

18. The router of claim 10, wherein in response to information indicating whether a processing unit has utilized the transmitted data, the controller is further configured to update the routing path.

19. A method of reconfiguring rendering units, the method comprising:
measuring, at a processor, workloads of the rendering units used in rendering a previous frame; and
reconfiguring the rendering units during rendering a current frame based on the workloads.

20. The method of claim 19, wherein the rendering units comprise at least one of a ray generator, a traversal (TRV) unit, an intersection test (IST) unit, or a shading unit.

21. The method of claim 19, wherein the rendering units comprise at least one of a vertex shader, a primitive generator, a raster, or a pixel shader.

22. The method of claim 19, wherein in response to performing rendering of a primary ray during ray tracing, a ray generator and a traversal (TRV) unit are allocated to a single processing unit.

23. The method of claim 19, wherein:
the rendering units are used in ray tracing,
the measuring of the workloads comprises measuring a degree of reflection or refraction based on a structure of an object included in 3D space and material characteristics of the object, and
the reconfiguring of the rendering units comprises determining a number of traversal (TRV) units to be allocated based on the measured degree of reflection and refraction.

24. The method of claim 19, wherein in response to performing rendering of a secondary ray during ray tracing, a shading unit and a ray generator are allocated to a single processing unit.

25. A non-transitory computer-readable recording medium having embodied thereon a program for executing the method of claim 19 on a computer.

26. An apparatus for reconfiguring rendering units, the apparatus comprising:
a workload measurer configure to measure workloads of the rendering units used in rendering of a previous frame; and
a reconfigurer configure to reconfigure the rendering units during rendering of a current frame based on the workloads.

27. The apparatus of claim 26, wherein the rendering units comprise at least one of a ray generator, a traversal (TRV) unit, an intersection test (IST) unit, or a shading unit.

28. The apparatus of claim 26, wherein in response to performing rendering of a primary ray during ray tracing, a ray generator and a traversal (TRV) unit are allocated to a single processing unit.

29. The apparatus of claim 26, wherein:
the rendering units are used in ray tracing,
the workload measurer is further configured to measure a degree of reflection or refraction based on a structure of an object included in 3D space and material characteristics of an object, and
the reconfigurer is further configured to allocate the number of traversal (TRV) units based on the measured degree of reflection and refraction.

30. The apparatus of claim 26, wherein in response to performing rendering of a secondary ray during ray tracing, a shading unit and a ray generator are allocated to a single processing unit.
